(19) United States
(12) Patent Application Publication
(10) Pub. No.: US 2025/0116858 A1
(43) Pub. Date: Apr. 10, 2025

(54) DEVICE, METHOD AND COMPUTER-READABLE STORAGE DEVICE FOR CONTROLLING ACTIVE OCCLUSION SUBSYSTEM

(71) Applicant: LUMUS LTD., Ness Ziona (IL)

(72) Inventor: Tsion EISENFELD, Ashkelon (IL)

(73) Assignee: LUMUS LTD., NESS ZIONA (IL)

(21) Appl. No.: 18/694,920

(22) PCT Filed: Sep. 30, 2022
(86) PCT No.: PCT/IB2022/059333

§ 371 Date: Mar. 22, 2024

Related U.S. Application Data
(60) Provisional application No. 63/250,623, filed on Sep. 30, 2021.

(51) Int. Cl. G02B 27/00; G02B 6/34; G02B 27/01

(52) U.S. Cl. CPC G02B 27/0018; G02B 6/34; G02B 27/0093; G02B 27/0172

(57) ABSTRACT

A device having an active occlusion subsystem having a liquid crystal panel configured to operate in one of a normally on mode to pass light or a normally off mode to block light, and one or more processors configured to determine a direction of light rays from a light source, and control, based on the direction of light rays received, at least one specific portion of the liquid crystal panel to switch from the normally on mode to block light and/or the at least one specific portion to switch from the normally off mode to pass light.

### CROSS-REFERENCE TO RELATED APPLICATIONS

The subject application claims the benefit of U.S. Provisional Patent Application No. U.S. 63/250,623, filed on Sep. 30, 2021. The entire disclosure of U.S. Provisional Patent Application No. U.S. 63/250,623 is incorporate herein by this reference.

### BACKGROUND

Many optical systems and devices, such as near eye display (NED) devices and head mounted display (HMD) devices, employ optical waveguides for image aperture expansion in one or more dimensions. A particular advantageous family of solutions for NEDs and HMDs are commercially available from Lumus Ltd. (Israel), and typically employ light-guide optical elements (LOEs) formed from a light-transmitting substrate with partially reflecting surfaces or other applicable optical elements for delivering an image into the eye of a user. In such solutions, image light waves, corresponding to an image collimated to infinity, are injected into the LOE by an image projector (referred to hereinafter as a POD). The injected image light waves are guided through the LOE by internal reflection, i.e., they are trapped between the external major surfaces of the substrate, and are subsequently gradually coupled out of the LOE by the partially reflective surfaces (or other applicable optical elements such as diffractive gratings) to an eye motion box (EMB), which is a region in which the eye of the user is located. The trapping of light waves by internal reflection may be effectuated by total internal reflection (TIR) or by angular selective coatings applied to the major surfaces of the substrate. Additional details of LOEs can be found in various commonly owned patents, for example, U.S. Pat. Nos. 8,432,614 B2 and 7,643,214 B2.

In augmented reality (AR) systems, the image that is generated by the POD and propagates by internal reflection is a virtual image which is “projected” (overlaid) onto a real-world scene background. This is effectuated by the substrate being partially transparent so that the user is able to view the virtual image and the real world simultaneously. In order to improve the user's perceived view of the virtual image, it may be desirable to at least partially occlude the portion of the background onto which the virtual image is projected, thereby presenting the user with a sharper and clearer virtual image. To achieve this goal, the occlusion of the portion of the background can be performed by partially blurring or blocking the background portion, and not necessarily completely blocking the background portion.

### SUMMARY

A device comprising: an active occlusion subsystem comprising a liquid crystal panel configured to operate in one of a normally on mode to pass light or a normally off mode to block light; and one or more processors configured to: determine a direction of light rays from a light source; and control, based on the direction of light rays received, at least one specific portion of the liquid crystal panel to switch from the normally on mode to block light and/or the at least one specific portion to switch from the normally off mode to pass light, is provided according to one embodiment.

A method of controlling a device comprising an active occlusion subsystem comprising a liquid crystal panel configured to operate in one of a normally on mode to pass light or a normally off mode to block light, the method comprising: determining a direction of light rays from a light source; and controlling, based on the direction of light rays received, at least one specific portion of the liquid crystal panel to switch from the normally on mode to block light and/or the at least one specific portion to switch from the normally off mode to pass light, is provided according to one embodiment.

A non-transitory computer-readable storage device is provided according to one embodiment. The non-transitory computer-readable storage device stores instructions for controlling a device comprising an active occlusion subsystem comprising a liquid crystal panel configured to operate in one of a normally on mode to pass light or a normally off mode to block light, the instructions causing one or more processors to at least perform: determining a direction of light rays from a light source; and controlling, based on the direction of light rays received, at least one specific portion of the liquid crystal panel to switch from the normally on mode to block light and/or the at least one specific portion to switch from the normally off mode to pass light.

### BRIEF DESCRIPTION OF DRAWINGS

FIG. 1 schematically illustrates a system including an eye tracking subsystem, a waveguide, and an active occlusion subsystem, according to one embodiment.

FIG. 2 schematically illustrates how a perceived image is the result of a projected virtual image overlapping a far-field background occlusion generated by the occlusion subsystem, according to one embodiment.

FIG. 3 schematically illustrates stages in the flow of an occlusion process, according to one embodiment.

FIG. 4 illustrates a sampling of deployment configurations of the occlusion subsystem, according to some embodiments.

FIGS. 5-7 illustrate effects of switching of a liquid crystal panel on incoming light, according the one embodiment.

FIGS. 8 AND 9 illustrate the general concept of occlusion and technical challenges associated therewith.

FIG. 10 schematically illustrates a system for mitigating stray light effects according to one embodiment.

FIG. 11 schematically illustrates a system for mitigating the effects of ghost images, according to one embodiment.

FIG. 12 schematically illustrates a system having an occlusion subsystem used in combination with a lens, according to one embodiment.

FIG. 13 schematically illustrates various configurations of a system having an occlusion subsystem and a lens, according to some embodiments.

FIGS. 14-17 schematically illustrate occlusion subsystems having cross polarizers, according to some embodiments.

FIG. 18 schematically illustrates propagation of ghost light in the absence of an occlusion subsystem.

FIG. 19 schematically illustrates an occlusion subsystem in combination with a 2D waveguide arrangement formed from a 1D LOE and an HLOE, according to one embodiment.

FIG. 20 illustrates occlusion subsystem functions to occlude light impinging on an HLOE portion of a waveguide arrangement, according to one embodiment.

FIG. 21 illustrates one occlusion subsystem deployed in association with a front surface of an LOE, and another occlusion subsystem deployed in association with a back surface of the LOE, according to one embodiment.

FIG. 22 illustrates two occlusion subsystems deployed in association with a 2D waveguide arrangement having a 1D LOE and HLOE, according to one embodiment.

### DETAILED DESCRIPTION

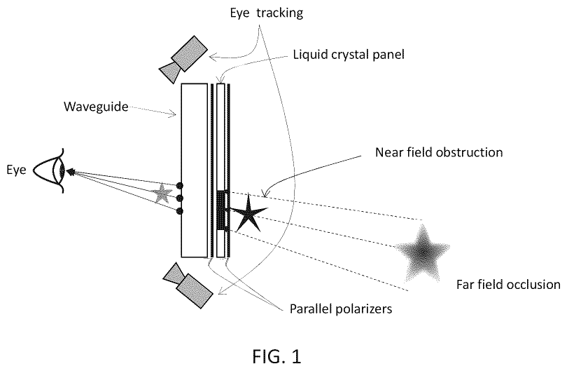

FIG. 1 schematically illustrates a system according to a non-limiting embodiment of the present disclosure. The system generally includes an eye tracking subsystem (represented schematically as a pair of cameras, and referred to interchangeably as “eye tracker”), a waveguide (e.g., LOE) having at least two major external surfaces and configured to guide image light (a virtual image) by internal reflection whereby the guided light is trapped within the waveguide by internal reflection at the major external surfaces, and an active occlusion subsystem associated with the waveguide and formed from a liquid crystal panel sandwiched between two polarizers. The waveguide and the occlusion subsystem (and its components) can be assembled with air gaps or partially or completely bonded.

Although not illustrated, the waveguide includes or is associated with an optical coupling-in configuration (such as a coupling-in reflector or coupling prism) for coupling image light (virtual image) from the POD into the waveguide so as to propagate within the waveguide by internal reflection. The waveguide also typically includes or is associated with an optical coupling-out configuration, which in one embodiment is implemented as an array of mutually parallel partially reflective surfaces deployed obliquely to the major external surfaces of the waveguide, for coupling the virtual image out of the waveguide toward an eye of the viewer (in other words, for “projecting” the virtual image). As mentioned above, other optical coupling-out configurations are contemplated herein, including diffractive coupling elements such as diffractive grating or holographic volume elements deployed on one of, or between the major external surfaces of the waveguide.

The eye tracker functions to detect the gaze direction of the eye when the eye views a virtual object (e.g., small star) projected by the waveguide. Eye trackers in NED and HMD devices can include optics for directing light rays reflected from the eye to one or more image or other sensor(s) which capture/detect the reflected eye light, and some processing components (e.g., computer processor(s) and/or a computer-readable storage device storing instructions for configuring a computer processor(s)) or circuitry for determining eye gaze direction (visual angular direction) based on the light captured/detected by the sensor(s). Details of exemplary eye trackers can be found in commonly owned U.S. Pat. No. 10,520,732 B2 and commonly owned U.S. Patent Application Publication No. US 2020/0241308 A1.

Based on the determined gaze direction, an appropriate voltage is applied to at least one specific portion of the liquid crystal panel in accordance with an input control signal (either from the processing circuitry of the eye tracker, or from a separate control system having a computer processor and/or a computer-readable storage device storing instructions for configuring a computer processor(s) that is linked to the eye tracker), which changes the fast axis orientation of the liquid crystal molecules in the (at least one specific) portion of the liquid crystal panel such that the occlusion subsystem extinguishes and blocks (or partially blocks) real-world scene light coming from that same gaze direction. As a result, a dark or darker area overlapping the virtual image signal is generated.

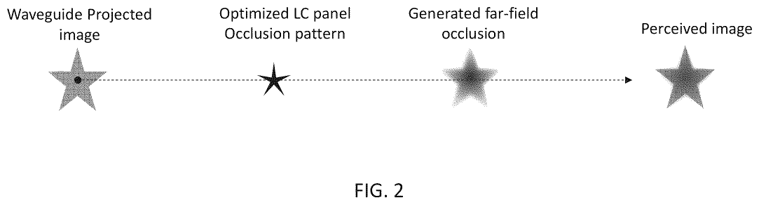

FIG. 2 schematically illustrates how the perceived image is the result of a projected virtual image overlapping a far-field background occlusion. The occlusion is generated by the occlusion subsystem (liquid crystal panel in combination with the two polarizers). The liquid crystal panel functions to switchably/selectively retard the light polarization according to an optimized pattern. Light coming from the projected image background is then occluded. The user/viewer will then perceive a virtual image from which the background has been effectively subtracted/removed. The resultant viewed image (perceived image in FIG. 2) will be less transparent than without the occlusion, and thus appears more realistic to the viewer.

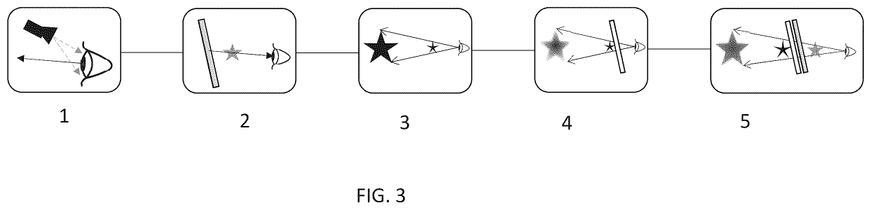

FIG. 3 schematically illustrates the stages in the flow of the occlusion process. At stage 1, the eye tracker performs visual angular direction tracking by detecting/determining the gaze direction of the eye. At stage 2, the corresponding virtual image that is projected at the determined gaze direction is determined. At stage 3, a near-field pattern, to be generated by the occlusion subsystem, is optimized so as to cover the virtual object area in the far-field. The near field pattern shape and size is chosen so as to obstruct the least peripheral background scene possible, and still occlude enough light coming from the gaze direction. The occlusion ratio between the peripheral scene and the gaze direction scene can be modified by reshaping and resizing the near-field pattern. At stage 4, the occlusion subsystem generates the required retardance area according to the optimized near-field pattern. As a result, the light coming from the desired far-field background is obstructed. At stage 5, background occlusion and virtual image overlapping is performed whereby the virtual image is projected and overlaps the created obstruction.

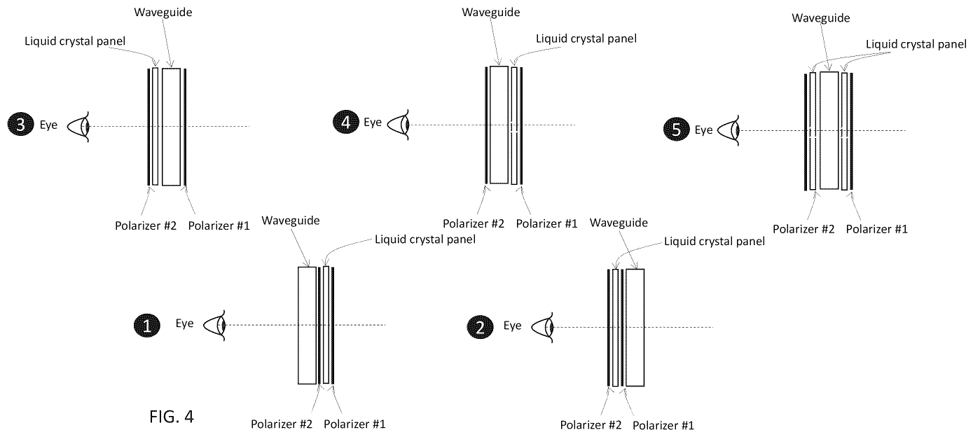

It is noted that FIG. 1 illustrates a non-limiting embodiment employing a particular deployment configuration of the occlusion subsystem. Other embodiments which employ various other deployment configurations are contemplated herein. FIG. 4 illustrates a sampling of some such deployment configurations, labeled 1-5. (Configuration 1 corresponds to the configuration illustrated in FIG. 1, in which the waveguide is deployed between the viewer's eye and the occlusion subsystem). In configuration 2, the occlusion subsystem is deployed between the viewer's eye and the waveguide. This configuration enables occlusion of the image background, but also enables blocking of light that induces ghost images, as well as stray light, which further improves the perceived image. This configuration may also be practical when the virtual image coupled out from the waveguide is polarized. Otherwise, the polarizer will cut part of the image brightness.

In configuration 3, the liquid crystal panel and one of the polarizers are deployed between the eye and the waveguide (i.e., in association with the “back” surface of the waveguide), and the other polarizer is deployed in association with the opposite (“front”) surface of the waveguide. Configuration 4 is similar to configuration 3, but the liquid crystal panel is deployed in association with the front surface of the waveguide. Configuration 5 is a combination of configurations 3 and 4, whereby two liquid crystal panels are deployed (one in association with the front waveguide surface, and the other in association with the back waveguide surface).

In the present embodiments, the two polarizers of the occlusion subsystem have the same orientation (i.e., the same transmission axis), such that when no voltage is applied to the liquid crystal panel the occlusion subsystem allows light to pass through the occlusion subsystem without being affected by the occlusion subsystem. The transmission axis of the polarizers can be vertical, horizontal or somewhere therebetween (diagonal), depending on the specific implementation and/or requirements of the system. As will be discussed, other polarizer deployment schemes, including using cross-polarizers, are also contemplated herein.

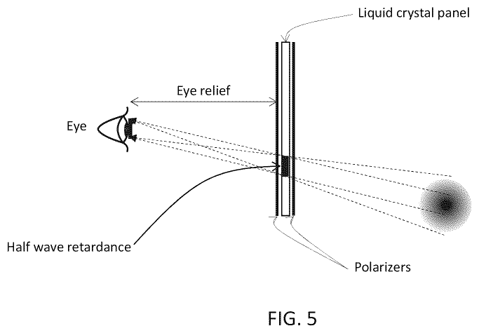

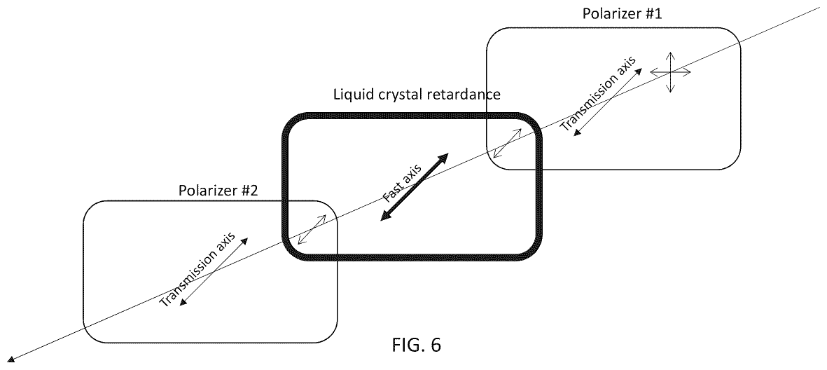

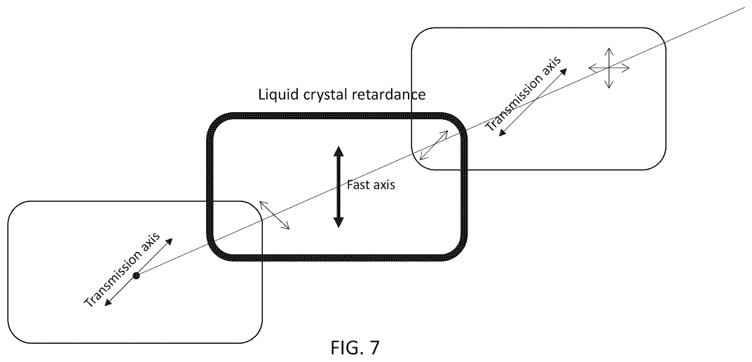

The effects of the switching of the liquid crystal panel on incoming light will now be described with reference to FIGS. 5-7. When off, light can pass through the polarizers essentially unperturbed and reach the eye. This is illustrated in FIG. 6, in which the fast axis of the liquid crystal molecules is aligned with the aligned transmission axes of the polarizers. When parts of the liquid crystal panel are active (by applying a voltage across electrodes of the liquid crystal panel, for example in response to a control signal), the liquid crystal pixels generate a half wave retardance so the light will be absorbed by the internal polarizer. This is illustrated in FIG. 7, in which the fast axis of the liquid crystal molecules is not aligned with the aligned transmission axes of the polarizers, thereby applying retardance to the light.

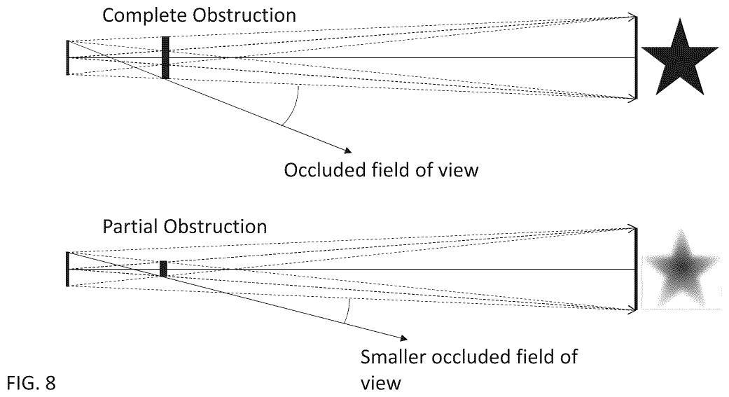

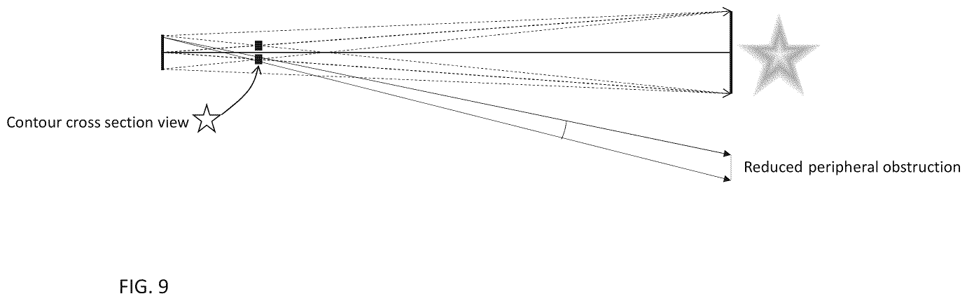

The general concept of occlusion and the technical challenges associated therewith will now be discussed with reference to FIGS. 8-9. Looking first at FIG. 8, it is noted that occluding a far field object is technically challenging by virtue of the fact that the farther the obstruction is from the object, the more difficult it is to hide only this object without occluding the scene around it. In order to remedy this, a smaller obstruction is generated so the scene will be less affected. As a result, the object is not entirely occluded. The center region of the object will be well darkened, and the peripheral region will be partially darkened only. In order to improve the darkening of the peripheral region of the object, the obstruction needs to be virtually approached to the object. Note that for convenience the illustrated scheme shows rays corresponding to only half of the eye pupil.

In order to mitigate the peripheral scene occlusion, a partial near-field obstruction can be produced. As a result, the far field occlusion is limited, and the background to be occluded will not be totally obstructed but will appear darker. The center of the occlusion will be the darkest part of the occlusion and its edges the less. The partial occlusion will allow a better augmented reality user experience.

Turning now to FIG. 9, the peripheral visibility can be further improved by applying a holed pattern at the liquid crystal layer of the liquid crystal panel.

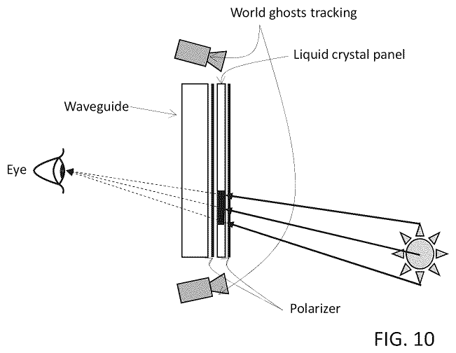

As mentioned above, the occlusion subsystem according to embodiments of the present disclosure are also applicable for mitigating effects of stray light. Turning now to FIG. 10, there is schematically illustrated a system for mitigating stray light effects. The system is in general similar to the system illustrated and described with reference to FIG. 1, except here the eye tracker is replaced by a “world ghosts tracker” (which can include components generally similar to the eye tracker of the previous embodiments) deployed in facing relation to the real-world scene. The world ghost tracker functions to sense/detect/image problematic sources of light in the real-world scene that produce stray light rays, and determine the direction of arrival of stray light rays (produced by such problematic sources). When stray light from a source projects light towards the eye, the world ghost tracker detects the direction of arrival of such light. And the occlusion subsystem blocks the stray light coming from that same direction. As a results, a dark area, overlapping the stray light, is generated.

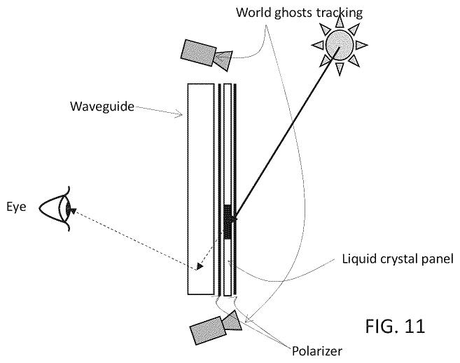

Similar principles can be applied to mitigate the effects of ghost images. In the present context, ghost images are generated from stray light that is coupled into the waveguide and is coupled out of the waveguide by the optical coupling-out configuration, which can interfere with the user's view of the projected virtual image (as well as the user's view of the real-world scene). FIG. 11 schematically illustrates a system for mitigating the effects of ghost images. The system is generally similar to that of the system illustrated in FIG. 10. When light from a source that in the absence of the occlusion subsystem would generate a ghost image projects light towards the user's eye, the world ghost tracker detects the direction of the light. In response, the occlusion subsystem panel blocks the light (from the source) coming from the same direction. As a results, no ghost is generated and directed to the eye.

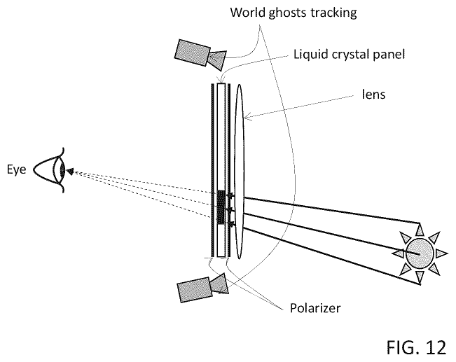

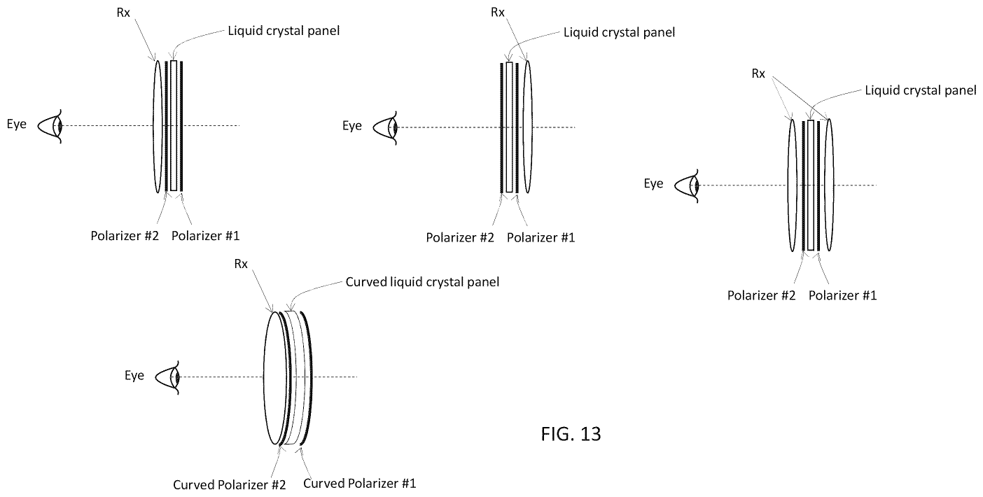

The occlusion subsystem of the present disclosure can also be used to advantage in non-NED/HMD applications, for example with lenses or automotive applications. FIG. 12 schematically illustrates an exemplary embodiment of a system having an occlusion subsystem used in combination with a lens (which can be a prescription (Rx) lens used in prescription eyeglasses). The system of FIG. 12 operates generally like that of FIG. 10, whereby the direction of stray light is detected by the world ghost tracking subsystem, and the occlusion subsystem blocks the stray light coming from that same direction. As a result, a dark area, overlapping the stray light, is generated. FIG. 13 schematically illustrates various configurations of a system having an occlusion subsystem and a lens (e.g., Rx lens). In the configurations illustrated in FIG. 13, the world ghosts tracking subsystem is not shown for clarity of presentation. In one of the configurations of FIG. 13, the occlusion subsystem is deployed in front of the lens (i.e., the lens is positioned between the eye and the occlusion subsystem). In another one of configurations, similar to as illustrated in FIG. 12, the occlusion subsystem is deployed behind the lens (i.e., the occlusion subsystem is deployed between the eye and the lens). In a further configuration, the occlusion subsystem is deployed together with a lens assembly formed from two lenses (although more than two lenses are possible). Here, the occlusion subsystem is sandwiched between a pair of lenses. In yet a further configuration, the polarizers and liquid crystal panel of the occlusion subsystem have a curvature that preferably corresponds to the curvature of the Rx lens. In the configurations illustrated in FIGS. 12 and 13, the lenses and the occlusion subsystem (and its components) can be assembled with air gaps or partially or completely bonded. It is noted that FIG. 13 illustrates only a sampling of potential configurations of an occlusion subsystem-lens combination.

In automotive applications, the occlusion subsystem can be deployed in association with the windshield of a vehicle whereby the world ghost tracker determines the incident direction of stray light rays, and the occlusion subsystem functions to occlude stray light (e.g., sunlight) impinging on the eye of a driver of the vehicle based in part on the stray light direction determination. In automotive applications, the occlusion subsystem may also be deployed in association with the driver and/or passenger windows of the vehicle, as well as portions of the windshield that are in front of the front-seat passenger. In this context, the vehicle can be an automobile (car), bus, truck (e.g., tractor-trailer), etc. Other transportation-related applications of the occlusion subsystem are also contemplated herein, including deployment of the occlusion subsystem in association with passenger windows on aircraft and/or the windshield of the aircraft cockpit, as well as deployment in association with windows and/or the windshield of a train. Furthermore, the occlusion subsystem of the present disclosure can be deployed in association with windows of any building or structure, such as homes and offices.

It is noted that in many non-NED/HMD applications of the occlusion subsystem, such as deployment of the occlusion subsystem in combination with corrective lenses (FIGS. 12 and 13) or in association with windows of structures and/or transportation vehicles, it may be beneficial to employ an eye tracker (similar to as in FIG. 1) as part of the occlusion subsystem in addition to the world ghosts tracking. This can enable the occlusion subsystem to detect the user's eye position and gaze direction, as well as the direction from which stray light will arrive, and thereby properly block the stray light coming from the same or similar direction (or with a certain viewing range based on the user's gaze direction) as the user's gaze direction.

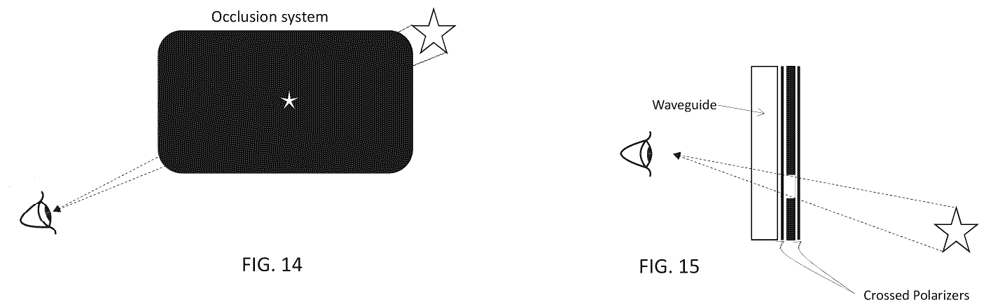

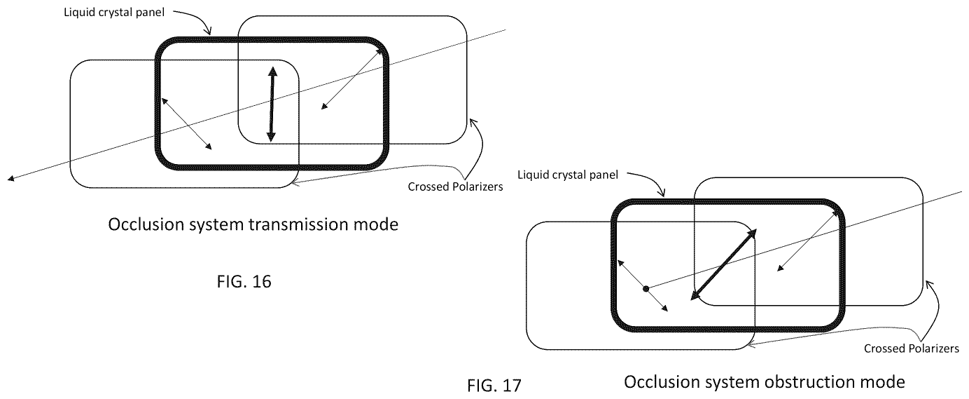

The embodiments described thus far have pertained to occlusion subsystems having polarizers having the same orientation (i.e., the same transmission axis). However, other embodiments are possible in which cross polarizers are employed. FIGS. 14-17 schematically illustrate such an embodiment. Here, the occlusion subsystem operates in a “normally off” mode such that when no voltage is applied to the liquid crystal panel, the occlusion subsystem blocks all light (FIGS. 14 and 17), and when a voltage is applied to the liquid crystal panel the occlusion subsystem passes some light (FIGS. 15 and 16). Such embodiments may be particularly applicable in mixed reality systems so that the user can see a real object in a virtual scene.

Thus far, the waveguides that operate together with occlusion subsystems have been described as waveguides that perform aperture expansion in a single dimension (1D). However, the occlusion subsystems according to present disclosure are equally applicable to waveguides that perform aperture expansion in two dimensions. Two-dimensional (2D) aperture expanding waveguides have been developed based on utilizing two parallel-faced slabs of transparent material, each having parallel partial reflectors (referred to as “facets”) obliquely angled relative to the respective parallel faces. The facets of the two slabs are deployed at different respective orientations (in some cases mutually orthogonal orientations), such that part of the image injected into the first slab (referred to as HLOE) is coupled out by the facets of the HLOE so as to expand the aperture in a first dimension. The coupled-out image from the HLOE is then coupled into the second slab (the LOE), where part of the image is coupled out by the facets of the LOE so as to expand the aperture in a second dimension. Solutions for 2D expansion utilizing the aforementioned HLOE are also commercially available from Lumus Ltd. (Israel), and details of such HLOE waveguides can be found in commonly owned International Patent Application Publication WO 2020/049542 A1.

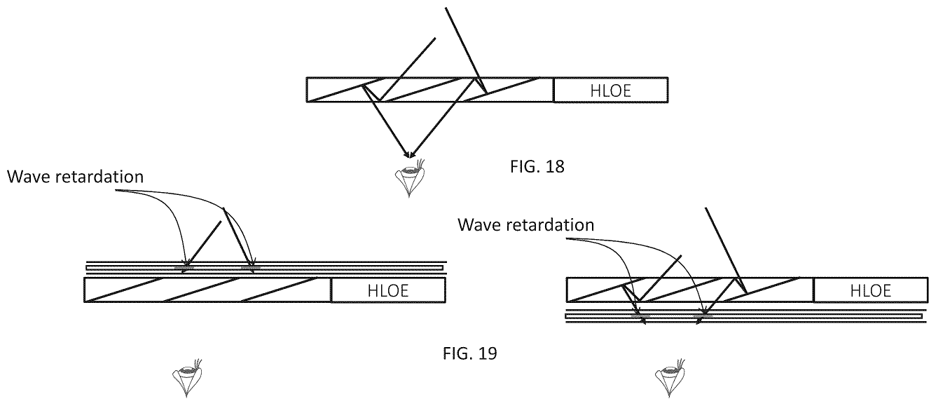

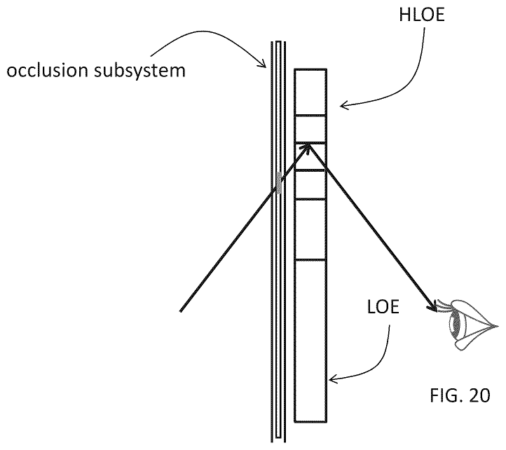

Bearing the above in mind, FIG. 18 schematically illustrates propagation of ghost light in the absence of an occlusion subsystem, and FIG. 19 schematically illustrates an occlusion subsystem in combination with a 2D waveguide arrangement formed from a ID LOE and an HLOE. In the configuration illustrated in FIG. 19, the occlusion subsystem functions to occlude the light that is projected through the ID LOE portion of the waveguide arrangement. In FIG. 20, the occlusion subsystem functions to occlude the light impinging on the HLOE portion of the waveguide arrangement. Here, since the HLOE (the upper part of the waveguide) is not located in front of the user's eyes, its surface can be completely hidden (obstructed) such that no occlusion shape optimization is needed, thereby reducing computing and electrical power.

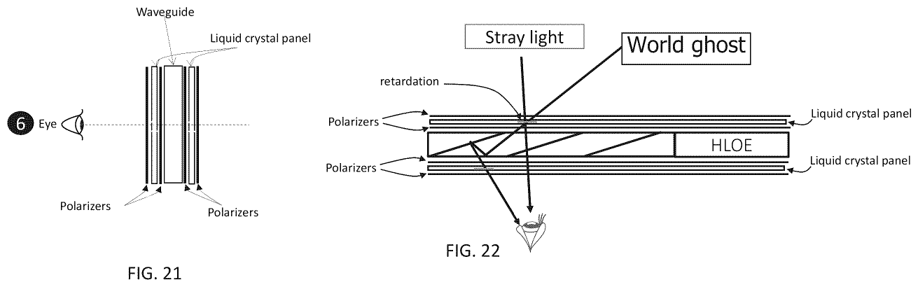

Although the embodiments described thus far have pertained to using a single occlusion subsystem in combination with a ID or 2D waveguide, other embodiments are possible in which a pair of occlusion subsystems are deployed. FIG. 21 illustrates an embodiment in which one occlusion subsystem is deployed in association with the front surface of the LOE, and another occlusion subsystem is deployed in association with back surface of the LOE. FIG. 22 illustrates a similar embodiment, except the two occlusion subsystems are deployed in association with a 2D waveguide arrangement having a 1D LOE and HLOE.

The embodiments illustrated in FIGS. 21 and 22 are of particular advantage when light rays from two or more sources needs to be obstructed, where the two light rays have different angle of incidence (AOI). When using a single occlusion subsystem (for example as illustrated in FIGS. 1 and 19), if the two light rays impinge on the same area of the waveguide, there may be conflict as to which light ray is occluded in priority by the single occlusion subsystem. In order to optimize the obstruction, the liquid crystal retardation should be adapted to the light angle of incidence and wavelength. When light corresponding to two different AOIs impinge the same liquid crustal area, the liquid crystal retardation cannot be optimum for both light sources. To overcome this conflict, the retardation can be corrected by adding one or more additional occlusion subsystems (i.e., additional liquid crystal layers between polarizers).

When used in NED/HMD applications, the occlusion subsystems of the present disclosure are suitable for use with waveguides that utilize partially reflecting surfaces as the optical coupling-out configuration for coupling light out of the waveguides, as well as other waveguide technologies that rely on other implementations of optical coupling-out configurations, such as diffractive gratings.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A device comprising:
an active occlusion subsystem comprising a liquid crystal panel configured to operate in one of a normally on mode to pass light or a normally off mode to block light; and
one or more processors configured to:
determine a direction of light rays from a light source; and
control, based on the direction of light rays received, at least one specific portion of the liquid crystal panel to switch from the normally on mode to block light and/or the at least one specific portion to switch from the normally off mode to pass light.

2. The device according to claim 1, further comprising:
a waveguide comprising:
two major external surfaces configured to guide a virtual image, coupled into the waveguide from an image projector, by internal reflection; and
a coupling-out configuration,
wherein the liquid crystal panel is configured to operate in the normally on mode to pass light.

3. The device according to claim 2,
wherein the one or more processors are configured to, in determining the direction of light rays from the light source, control one or more sensors to detect a gaze direction of an eye.

4. The device according to claim 3,
wherein the one or more processors are configured to:
determine a corresponding virtual image that is coupled-out by the coupling-out configuration in the gaze direction detected;
determine a near-field pattern corresponding to the virtual image; and
control, based on the direction of the light rays received and the near-field pattern determined, the at least one specific portion of the liquid crystal panel to switch from the normally on mode to block light such that light coming from a far-field background in the direction of the light rays received, is occluded and the virtual image is projected to at least partially overlap the at least one specific portion occluded.

5. The device according to claim 4,
wherein the one or more processors are configured to:
optimize the near-field pattern by performing one or more of reshaping and resizing the near-field pattern; and
control, based on the direction of the light rays received and the near-field pattern optimized, the at least one specific portion of the liquid crystal panel to switch from the normally on mode to block light.

6. The device according to claim 4,
wherein the one or more processors are configured to:
optimize the near-field pattern by applying a holed pattern to the near-field pattern; and
control, based on the direction of the light rays received and the near-field pattern optimized, the at least one specific portion of the liquid crystal panel to switch from the normally on mode to block light.

7. The device according to claim 1,
wherein the one or more processors are configured to, in determining the direction of light rays from the light source, control one or more sensors to detect a direction of arrival of stray light rays towards the active occlusion subsystem.

8. The device according to claim 7, further comprising:
one or more lenses,
wherein the one or more processors are configured to, in determining the direction of light rays from the light source, control one or more sensors to detect a direction of arrival of the stray light rays through the one or more lenses toward the active occlusion subsystem.

9. The device according to claim 1, further comprising:
wherein the one or more processors are configured to, in determining the direction of light rays from the light source, control one or more sensors to detect a direction of arrival of stray light rays through a windshield or window of a vehicle toward the active occlusion subsystem.

10. The device according to claim 2,
wherein the one or more processors are configured to in determining the direction of light rays from the light source, control one or more sensors to detect a direction of arrival of stray light rays that is coupled into the waveguide and coupled out of the waveguide by the coupling-out configuration.

11. A method of controlling a device comprising an active occlusion subsystem comprising a liquid crystal panel configured to operate in one of a normally on mode to pass light or a normally off mode to block light, the method comprising:
determining a direction of light rays from a light source; and
controlling, based on the direction of light rays received, at least one specific portion of the liquid crystal panel to switch from the normally on mode to block light and/or the at least one specific portion to switch from the normally off mode to pass light.

12. The method according to claim 11,
wherein the device further comprises a waveguide comprising:
two major external surfaces configured to guide a virtual image, coupled into the waveguide from an image projector, by internal reflection; and
a coupling-out configuration,
wherein the liquid crystal panel is configured to operate in the normally on mode to pass light, and
wherein determining the direction of light rays from the light source comprises controlling one or more sensors to detect a gaze direction of an eye.

13. The method according to claim 12, further comprising:
determining a corresponding virtual image that is coupled-out by the coupling-out configuration in the gaze direction detected;
determining a near-field pattern corresponding to the virtual image; and
controlling, based on the direction of the light rays received and the near-field pattern determined, the at least one specific portion of the liquid crystal panel to switch from the normally on mode to block light such that light coming from a far-field background in the direction of the light rays received, is occluded and the virtual image is projected to at least partially overlap the at least one specific portion occluded.

14. The method according to claim 13, further comprising:
optimizing the near-field pattern by performing one or more of reshaping and resizing the near-field pattern; and
controlling, based on the direction of the light rays received and the near-field pattern optimized, the at least one specific portion of the liquid crystal panel to switch from the normally on mode to block light.

15. The method according to claim 13, further comprising:
optimizing the near-field pattern by applying a holed pattern to the near-field pattern; and
controlling, based on the direction of the light rays received and the near-field pattern optimized, the at least one specific portion of the liquid crystal panel to switch from the normally on mode to block light.

16. The method according to claim 11,
wherein determining the direction of light rays from the light source comprises controlling one or more sensors to detect a direction of arrival of stray light rays towards the active occlusion subsystem.

17. The method according to claim 16,
wherein the device comprises one or more lenses, and
wherein determining the direction of light rays from the light source comprises controlling one or more sensors to detect a direction of arrival of the stray light rays through the one or more lenses toward the active occlusion subsystem.

18. The method according to claim 11,
wherein determining the direction of light rays from the light source comprises controlling one or more sensors to detect a direction of arrival of stray light rays through a windshield or window of a vehicle toward the active occlusion subsystem.

19. The method according to claim 12,
wherein determining the direction of light rays from the light source comprises controlling one or more sensors to detect a direction of arrival of stray light rays that is coupled into the waveguide and coupled out of the waveguide by the coupling-out configuration.

20. A non-transitory computer-readable storage device storing instructions for controlling a device comprising an active occlusion subsystem comprising a liquid crystal panel configured to operate in one of a normally on mode to pass light or a normally off mode to block light, the instructions causing one or more processors to at least perform:
determining a direction of light rays from a light source; and
controlling, based on the direction of light rays received, at least one specific portion of the liquid crystal panel to switch from the normally on mode to block light and/or the at least one specific portion to switch from the normally off mode to pass light.
